(19) United States
(12) Patent Application Publication
(10) Pub. No.: US 2005/0286772 A1
(43) Pub. Date: Dec. 29, 2005

(54) Multiple classifier system with voting arbitration

(75) Inventor: Lawrence E. Albertelli, Owego, NY (US)

Correspondence Address: TAROLLI, SUNDHEIM, COVELL & TUMMINO LLP, Suite 1111, 526 Superior Avenue, CLEVELAND, OH, 44114, US

(73) Assignee: Lockheed Martin Corporation

(21) Appl. No.: 10/876,175

(22) Filed: Jun. 24, 2004

(51) Int. Cl. G06K 9/62

(52) U.S. Cl. 382/224

(57) ABSTRACT

Systems and methods are provided for classifying a subject into one of a plurality of output classes. An input pattern representing the subject is classified at a plurality of pattern recognition classifiers to obtain a ranked set of at least two classifier outputs at each classifier. A classifier output includes an associated output class, output score, and ranking. Each classifier output is mapped to a corresponding weight value according to its associated output class, output score, and ranking. The weight values for the classifier outputs are combined according to a voting algorithm to determine an output class associated with the subject.

### BACKGROUND OF THE INVENTION

1. Technical Field

The present invention relates generally to pattern recognition and classification and more specifically to systems and methods for classifying an input pattern via multiple classification systems.

2. Description of the Prior Art

Classifiers are computer algorithms which attempt to determine the class membership of an input pattern whose class is unknown. That is, a classifier can differentiate the class identity of an input pattern from that of other classes that it was trained with. There are many types of classifiers, for example, artificial neural networks, radial basis functions, and support vector machines.

A classifier must be trained with data from a representative sample of the classes that are to be differentiated. Once trained, a classifier can determine the class of an input pattern provided that an adequate sample of the input's member class was included in the training data. Training consists of presenting data from the training set in suitable form to the classifier and modifying the classifier's internal parameters until it can reliably distinguish one class from another among the classes within the training set.

Classifiers, in general, vary in their performance on a given training set. Performance is measured in terms of error rates on a given input data set. Several classifiers could have different error rates on the same data set. One classifier might perform better than the others on one particular class while another might excel at identifying yet a different class than the others. This fact makes it desirable to somehow combine the results of multiple classifiers to obtain a combined result which has a lower error rate than any of the individual classifiers.

There are a number of so-called voting techniques (also known as Ensemble Learning, Data Fusion, Combination of Classifiers, etc.) that can be used to combine the results of multiple classifiers in a way that results in better overall performance than any of the individual classifiers in the ensemble. The success of this technique requires that the classifiers be at least somewhat statistically independent. Voting techniques range from the simple to the complex. Some simple voting algorithms include, simple majority, Borda count, and sum rule. More complex techniques include logistic regression, Dempster-Shafer, and belief integration.

These methods generally assume that the individual classifiers output either some kind of probabilistic confidence level or rank in a list of possible classifications. A voting algorithm can be used to determine a consensus of the results. The voting algorithm will take ranked lists of candidate classifications from the ensemble of classifiers and output a new ranked list based on the consensus. In the case where a classifier does not output a Bayesian probability, use can be made of a confusion matrix as an estimate of the prior probability density function (pdf) of the individual classifiers to weight the votes from each classifier on each class. A confusion matrix gives a profile of a classifier indicating how well it classifies each class and where the errors lie.

One distinguishing feature of classifiers is that different classifiers output different ranges of values for their results. This is true even of classifiers of the same type. That is, the outputs of multiple classifiers are heterogeneous. For example, one artificial neural network could output a range of values from negative one to one, while another could output a range of values from one to ten. Yet another neural network might output a range of probabilities from zero to one. The output range depends on the specific architecture of the classifier.

### SUMMARY OF THE INVENTION

The intent of this invention is to illustrate a method of combining multiple classifiers whose outputs are heterogeneous and non-probabilistic, and which output a ranked list of choices. Use is made of a confusion matrix to map output activation values to Bayesian probability values which are then used to weight the inputs to the voting algorithm. The confusion matrix is a table of counts of the number of times a classifier identifies an input as a particular class versus its known class membership. From this, the conditional probability of correct identification can be obtained for all the classes in the training set.

In the literature, output mapping is usually done for the case of simple classifiers which output a single, non-probabilistic result. This invention extends this mapping capability to the general case where the classifiers output heterogeneous, non-probabilistic values in a list of ranked output values.

When each classifier is trained, a test set, different from the training set, is presented to the trained classifier. For each test example, the outputs of the classifier are ranked in order of decreasing value. The class identity and output value for each of the ranked outputs are then recorded. This is done for all test examples for each classifier.

For each classifier, the recorded lists are broken down by class and rank within the list, and are binned according to output value based on the number of outputs which fall into a particular choice for a particular class in the test set and the number of bins desired. The invention is not limited to this binning scheme. Other schemes may be adopted. A confusion matrix is then generated, based on the known truth of the examples, for each rank within the list, and each bin.

For example, assume that there are ten different classes. Each classifier outputs a ranked list of 10 values ranging from zero to one. Ten bins are desired. So, for each of the ten classes, there are ten ranked choices. For each choice, ten bins are created based on the values of however many outputs fall into a particular combination of class and ranking. The values are ordered in ascending order. The number of values used to determine bin boundaries is the total number of values that fall into that combination of class and ranking divided by the number of bins desired. If, in this example, one thousand values occur in a class-choice partition, the range of the first bin is based on the first one hundred values. The range of the second bin is based on the second one hundred values and so on. The ranges will not necessarily be equal in extent. For example, the first bin may be between 0 and 0.135. The second bin may be between 0.136 and 0.312, and so on. Also, it should be noted that bin boundaries will differ for a given bin for a given choice for a given class. The boundary values are preserved and used to determine which bin an output value falls in. A confusion matrix is generated for each choice-bin combination. So we end up with ten choices×ten bins, or one hundred confusion matrices for each classifier.

Probability values are then calculated for the entries in each confusion matrix. Each confusion matrix generates probabilities for every class. In the above example there would be ten probabilities for each confusion matrix. A lookup table is then generated that maps classifier output values to probability values based on class, rank, and bin value. This table is three-dimensional with axes for class, rank, and bin value. For the above example there would be one thousand entries. This is repeated for each classifier, such that there is a look-up table for each classifier.

During the operation of the combiner, an unknown input is presented to all of the classifiers. A ranked list of outputs is collected for each classifier. For each classifier, the outputs in the ranked list are mapped to probability values based on class, rank, and value, using the lookup table for that classifier. The list is then reordered by descending order of probability value. The same is done for the remaining classifiers' outputs.

The mapped probability values are then used to weight the votes in the voting process. An example of a simple voting algorithm is the sum rule. In the sum rule, for each class that is common to two or more classifiers in the ensemble, the probabilities are added. Then the list is reordered again in descending order of summed probabilities. The class that has the highest summed probability is chosen as having the highest probability of being correct. The procedure is repeated with each unknown input to be classified. The combined performance is generally better than that of each individual classifier.

This same technique can be used with any voting scheme. The above is provided as an example. The current application of this invention is to optical character recognition of mail but is not limited to this application.

Accordingly, a method and computer program product, are provided for classifying a subject into one of a plurality of output classes. An input pattern representing the subject is classified at a plurality of pattern recognition classifiers to obtain a ranked set of at least two classifier outputs at each classifier. A classifier output includes an associated output class, output score, and ranking. Each classifier output is mapped to a corresponding weight value according to its associated output class, output score, and ranking. The weight values for the classifier outputs are combined according to a voting algorithm to determine an output class associated with the subject.

In accordance with another aspect of the invention, a method and computer program product are provided for generating output mapping weights in a multiple classifier system. The classifier is trained on a plurality of training patterns. A plurality of test patterns are then classified to obtain a ranked set of at least two classifier outputs for each test pattern. Each test pattern has a known class membership. A given classifier output includes an associated output class, an associated output score range from a plurality of output score ranges, and associated ranking. The classifier outputs are sorted into a plurality of categories based on associated output classes, output score range, and rankings to generate at least two confusion matrices from the classifier outputs. Weight values are generated for at least one defined category of classifier outputs from at least two confusion matrices.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a multiple classifier system in accordance with one aspect of the present invention;

FIG. 2 illustrates an exemplary training system for a multiple classifier system in accordance with an aspect of the present invention;

FIG. 3 illustrates an exemplary confusion matrix in accordance with an aspect of the present invention;

FIG. 4 illustrates an exemplary classification system in accordance with an aspect of the present invention;

FIG. 5 is a flow diagram illustrating a training method for a multiple classifier system in accordance with an aspect of the present invention; and

FIG. 6 is a flow diagram depicting a classification method for a multiple classifier system in accordance with an aspect of the present invention.

### DETAILED DESCRIPTION OF THE DRAWINGS

FIG. 1 illustrates a multiple classifier system 10 in accordance with one aspect of the present invention. The multiple classifier arrangement operates to increase the accuracy of the classification system, decreasing the number of incorrectly classified samples associated with the system. A final system output is then selected according to the outputs of the various classifiers. A multiple classifier system in accordance with the present invention can be applied to any of a number of pattern recognition tasks, including, for example, optical character recognition (OCR), sensor fusion, speech translation, and image analysis in medical, military, and industrial applications.

It will be appreciated that the illustrated multiple classifier system 10 can be implemented as one or more computer programs, executable on one or more general purpose computers. Accordingly, any structures herein described can be implemented alternately as dedicated hardware circuitry for the described function or as a program code stored as part of a computer-assessable memory, such as a computer hard drive, random access memory, or a removable disk medium (e.g., magnetic storage media, flash media, CD and DVD media, etc.). Functions carried out by the illustrated system, but not helpful in understanding the claimed invention, are omitted from this diagram. For example, a system implemented as a computer program would require some amount of working memory and routines for accessing this memory. Such matters are understood by those skilled in the art, and they are omitted in the interest of brevity.

It will further be appreciated that when implemented as a computer program product, the multiple classifier system 10 can interact with other software program modules. For example, the system 10 can run within a computer operating system environment, utilizing data libraries available from the operating system. Similarly, the system can receive data from one or more other program modules, and provide data to other program modules that utilize the system output. Furthermore, the system 10 can reside on a remote computer system, whereby various system components and external resources can be linked via a computer network such as WAN, LAN, optical communication media, public switched telephone network, the global packet data communication network now commonly referred to as the Internet, any wireless network or any data transfer equipment offered by a service provider.

The illustrated classifier system classifies a given input pattern at N classifiers 12-14, where N is an integer greater than one. A given classifier (e.g., 12) can provide two or more ranked raw classifier outputs, each raw classifier output including a selected output class and an output score. The classifier outputs can be ranked according to their output scores or via any other means used by the classification technique associated with a given classifier. The classifiers can comprise any of a variety of recognition systems, including neural networks, support vector machines, statistical pattern recognition classifiers, or other suitable classification routines.

Each classifier provides its raw output to a respective one of a plurality of mapping components 16-18. A given mapping component (e.g., 16) receives the raw output from its associated classifier and determines appropriate weight values from the classifier output. For example, a mapping component 16 can determine the probability that a given class output represents the correct class membership for the input pattern according to its associated output score and ranking. The mapping component can be implemented, for example, as a three-dimensional look-up table that provides a weight value as a function of an output class, its associated rank, and the value of its associated output score relative to a plurality of defined output score ranges.

Once appropriate weight values have been calculated for the output of each classifier, the weighted classifier output is provided to an arbitrator 20. The arbitrator 20 determines an appropriate system output from the various classifier outputs according to a voting algorithm. The specific voting algorithm will vary with the application, but examples include a sum rule algorithm, a product rule algorithm, a class set reduction algorithm, logistic regression, and a Borda count algorithm. One skilled in the art will appreciate that other voting algorithms could be used for the described function.

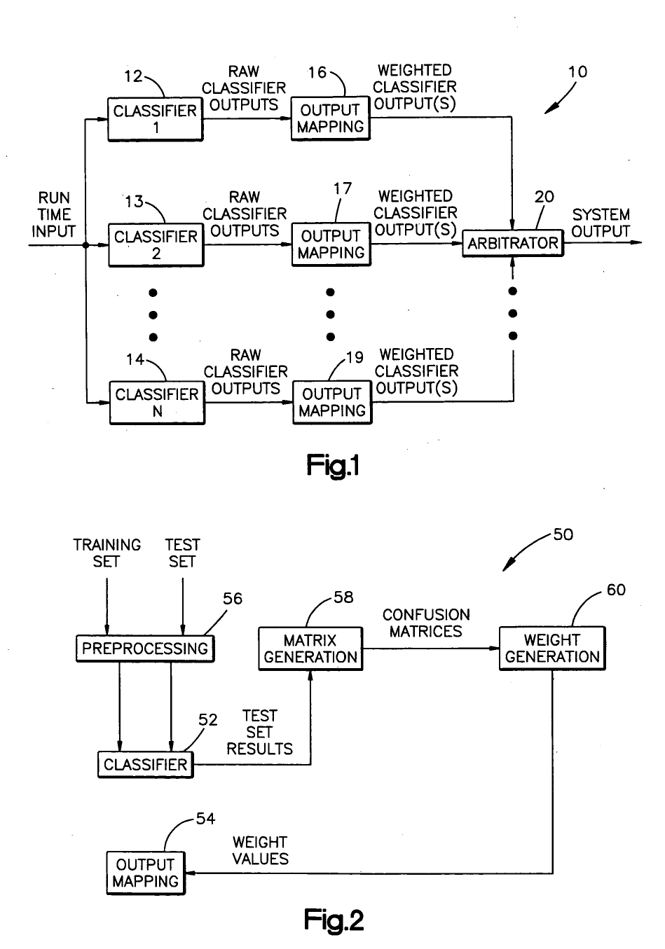

FIG. 2 illustrates an exemplary training system 50 for a multiple classifier system in accordance with an aspect of the present invention. The illustrated training system 50 provides appropriate training data for a given classifier 52 and an associated mapping component 54 for the recognition of plurality of output classes associated with the multiple classifier system. It will be appreciated that the training system 50 can be implemented as one or more computer programs, stored on computer readable media and executable on one or more general purpose computers.

Before a pattern is provided to the classifier in run-time operation, it must be reduced to a form appropriate for analysis by the pattern recognition system. A preprocessing component 56 is operative to reduce noise within a given pattern, segment desirable portions from the pattern, and extract data relating to features of interest from the segmented portions in the form of numerical feature vectors. It will be appreciated that the features of interest will vary with the nature of the pattern data and with the classification technique of the associated classifier 52. Each classifier in a multiple classifier system can utilize different features, and accordingly require different preprocessing components, to classify input patterns.

A set of training patterns, representing a plurality of output classes, can be provided to the preprocessing component 56. The training patterns for each class can be selected to represent a variety of examples of the class to train the classifier to account for the variance of the patterns within the class as well as the variance between the classes. The preprocessing component 56 segments the provided training patterns and extracts feature data from the samples according to the features utilized by the classifier 52. The classifier 52 is then trained on the extracted data to produce a plurality of training parameters associated with the system. For example, the training parameters can represent interconnection weights within a neural network classifier, descriptive statistical parameters for each class in a classifier utilizing radial basis functions, or similar useful values for the associated classifier.

Once the classifier is trained, a test set of patterns, representing the plurality of output classes, can be provided to the preprocessing component 56. The test set can also be selected to represent a variety of examples of the class, and will generally comprise different patterns than the training set. The preprocessing component 56 segments the provided test patterns and extracts feature data from the samples according to the features utilized by the classifier 52. The classifier 52 classifies each of the test samples and provides two or more ranked classifier outputs for each sample. Each classifier output includes an associated output class from the plurality of output classes and an associated output score.

The classifier outputs are provided to a matrix generation component 58 for analysis. The matrix generation component 58 combines the classifier results with the known class membership of the test samples to generate two or more confusion matrices for the classifier. An exemplary confusion matrix can be thought of as a two-dimensional histogram that tallies the classification results of a given test pattern into a histogram bin according to the associated output class determined at the classifier for the pattern and the actual class membership of the pattern. From this histogram, the accuracy of the classifier given a particular class, output range and ranking can be determined.

Each confusion matrix can compile classifier outputs from the test set having an associated output score range and ranking. For example, one confusion matrix may include only first ranked classifier outputs having an output score greater than a threshold value. A second matrix may only record second ranked outputs having an output score within a desired range. In an exemplary implementation, the ranges for the output scores can be determined according to the test results. For example, if ten separate ranges, or bins, of output scores are desired, the first output range can be defined as a range containing the top tenth of output scores. The generated confusion matrices are provided to a weight generation component 60. The weight generation component 60 assigns weight values to predetermined categories of classifier outputs according to the generated confusion matrices. These categories can be defined with respect to an associated output class, output class range, and ranking. For example, one category can include first ranked classifier outputs having an output score greater than a threshold value. A weight value for this category can be determined from the distribution of classifier outputs from the test set matching the defined characteristics of the category as recorded in a corresponding confusion matrix. In an exemplary embodiment, a look-up table can be generated from the weight values, with the weight values for a given category being retrievable according to the output class, output score range, and ranking associated with the category. Once the values for the table have been calculated, the generated weight values are provided to the output mapping component 54.

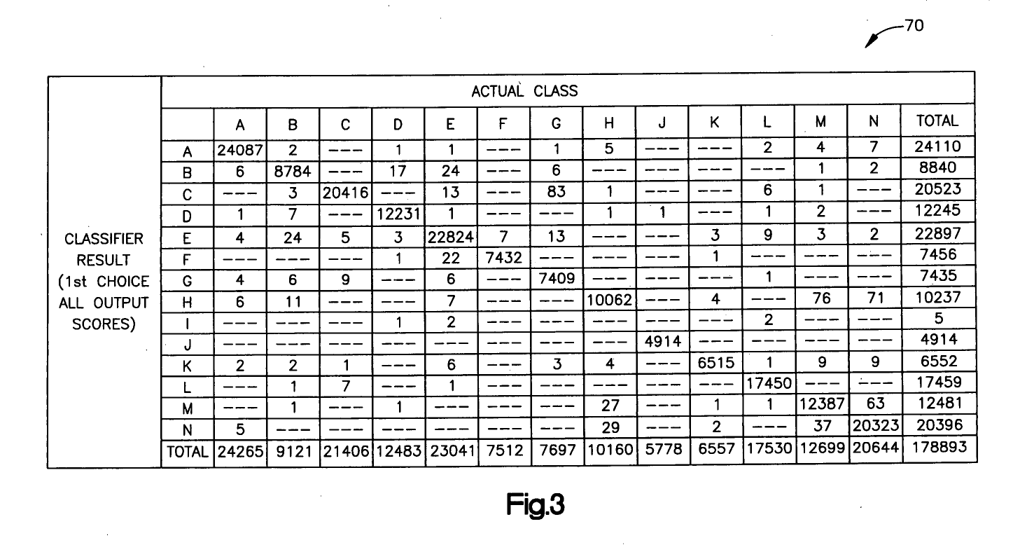

FIG. 3 illustrates an exemplary confusion matrix 70. As described above, a confusion matrix gives a profile of a classifier, indicating how well it classifies each class and where the errors are occurring. A classifier matrix is produced by providing a test set of input patterns with known class membership to a trained classifier. The classifier classifies the provided test patterns and determines one or more outputs, each output having an associated class and output score.

In the illustrated matrix 70, the columns represent the known class membership of the test samples. The rows indicate the associated class of the classifier output having the highest output score (i.e., first-ranked output scores). It will be appreciated, however, that a confusion matrix can be generated for a classifier for rankings other than first. In accordance with the present invention, a confusion matrix can be generated that deals only with a particular range, or bin, of output scores.

The accuracy of a classifier for a particular class can be estimated from the ratio of number of correct entries of the table for that class, represented as the intersection of the row and column associated with the class, to the total number of times that the classifier output the class. Additional data can be obtained by limiting the outputs recorded in the confusion matrix to outputs having a given ranking and output score. For example, a confusion matrix can be created showing only first-ranked classifier outputs having an output score greater than a threshold value. A number of these confusion matrices can be generated for a given classifier to provide a refined estimate of the accuracy of a classifier output given its associated ranking and output score.

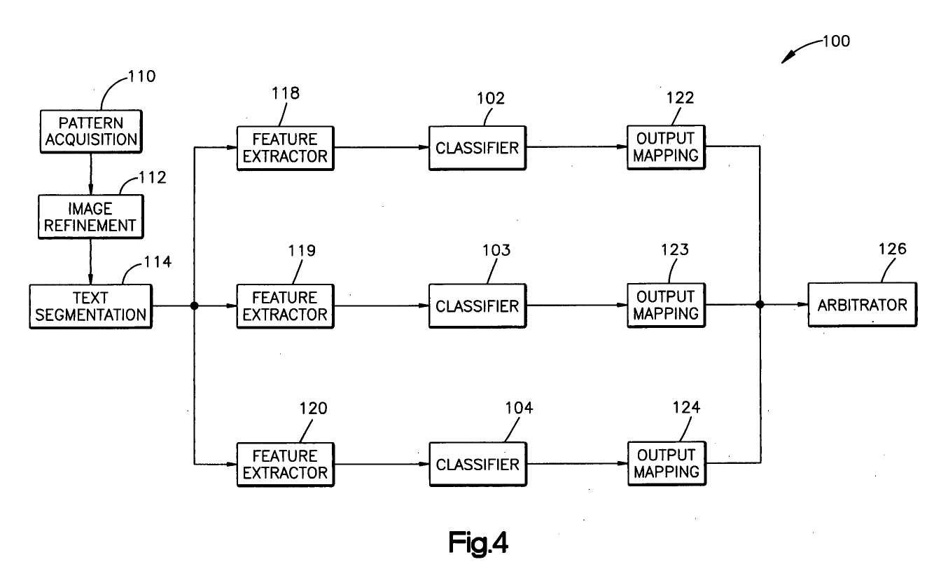

FIG. 4 illustrates an exemplary classification system 100 in accordance with an aspect of the present invention. The illustrated classification system 100 is an optical character recognition (OCR) system that acquires a digital image of text and identifies the individual characters. It will be appreciated that present invention is not limited to OCR applications. For example, the classification system can be utilized to sensor fusion applications, face recognition, speech recognition, and other pattern recognition applications. In a sensor fusion application, for example, each of the plurality of classifiers can interpret respective input patterns representing an object of interest from respective associated remote sensors to determine a final classification of the object. In the illustrated classification system, three classifiers 102-104 are illustrated, but it will be appreciated that more or less can be used. It will be further appreciated that the classification system 100, including the three classifiers 102-104, can be implemented as one or more computer programs stored on computer readable media and executable on one or more general purpose computers.

The classification process begins at a pattern acquisition component 110 with the acquisition of a digital input image, representing a block of text. The image acquisition component 110 can comprise a digital scanner or digital camera for acquiring these images. The text is then sent to an image refinement component 112, where the text is processed to enhance the text image, eliminate obvious noise, and otherwise prepare the candidate object for further processing.

The preprocessed text is then sent to a text segmentation component 114. Segmentation is necessary to divide the text into units that roughly correspond to the output classes of the classification system. For example, a typical OCR system is trained to recognize single, alphanumeric characters. Thus, the text segmentation stage 114 attempts to divide the text at the boundaries of the characters.

The segmented characters are then sent to a plurality of feature extractors 118-120. Each feature extractor is associated with one of the plurality of classifiers 102-104. A given feature extractor converts the segmented characters into a vector of numerical measurements, referred to as feature variables. The vector is formed from a sequence of measurements performed on the image. Many feature types exist and are selected based on the characteristics of the recognition problem. The selected features can vary at each of the plurality of feature extractors according to its associated classifier.

Each feature extractor (e.g., 118) provides an extracted feature vector to its associated classifier (e.g., 102). The classifiers 102-104 attempt to match the feature vector to one or more of a plurality of output classes associated with the classification system 100 using an associated classification technique and provided training data. In this process, one or more output classes are selected at each classifier and corresponding output scores are calculated. For example, an output score can comprise a confidence value reflecting the likelihood that the input pattern is actually associated with the selected output class. The output classes at each classifier (e.g., 102) are assigned ranks according to their associated output scores.

Any of a variety of classifier architectures and techniques can be utilized at the classifiers for making this determination. For example, the classifiers 102-104 can be implemented as any of a plurality of classifier models such as the back propagation neural network, one of its variants (e.g., QuickProp), auto-associative networks, self-organizing maps, radial basis function networks, and support vector machines. It will be appreciated that the specific architecture and technique can vary across systems and across the plurality of classifiers 102-104 within a single system.

For example, a classifier (e.g., 102) can be implemented as an artificial neural network (ANN). An ANN contains a plurality of nodes, each node being connected to at least one other node by one or more interconnections. Each interconnection between nodes is weighted, with the weights being determined according to training data. An ANN is trained to recognize one or more known training patterns and respond with an output vector indicating an output score for one or more output classes based upon the similarity of the input pattern to the training data provided for the one or more output classes.

Each of the plurality of classifiers 102-104 provides its selected output classes and their associated output scores to respective output mapping components 122-124. The output mapping components 122-124 map the outputs of each classifier to associated weight values according to their associated output class, ranking, and output score. In one implementation, the weight values produced from each classifier output can reflect the conditional probability that the input pattern is a member of the class associated with the output, given the output of the classifier.

In the illustrated example, each output mapping component (e.g., 122) comprises a three-dimensional look-up table that assigns a weight value to a given classifier output according to its associated class, ranking, and an associated output score range. For determining an appropriate output score range, the range of possible output scores for a classifier can be divided into a plurality of constituent ranges within the look-up table, and the classifier output can be assigned the range encompassing its associated output score. It will be appreciated that the composition of a given look-up table can be specific to its associated classifier and a given test set, and the composition of look-up tables can vary across systems and across the plurality of output mapping components 122-124 within a single system. For example, the output score ranges can differ across each class and classifier.

The determined weight values are then provided to an arbitrator 126. The arbitrator 126 selects an output class from the output classes represented by the classifier outputs from their associated weight values according to a voting algorithm. Any of a plurality of voting algorithms can be utilized in the arbitrator 126, including, for example, a Borda count voting scheme, sum rule combinations, and product rule combinations. An appropriate voting algorithm can be determined by experimentation for a desired application. In the illustrated example, a sum rule is applied, where the weight values for each output class are combined across the plurality of classifiers, and the class having the largest total sum is selected. It will be appreciated that different results can be achieved for the same weight values using different voting systems.

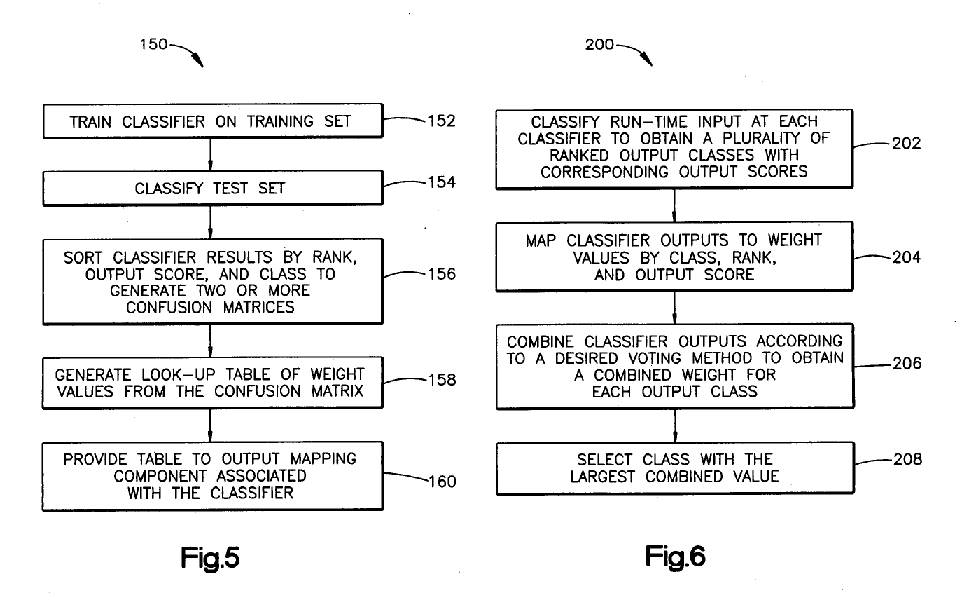

In view of the foregoing structural and functional features described above, methodologies in accordance with various aspects of the present invention will be better appreciated with reference to FIGS. 5-6. While, for purposes of simplicity of explanation, the methodologies of FIGS. 5-6 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 5 illustrates a flow diagram depicting a training method 150 for a multiple classifier system in accordance with an aspect of the present invention. The method 150 begins at step 152, where a classifier is trained on a set of training patterns. The specifics of training will vary for a given classifier, but generally speaking, feature data is extracted from input patterns having known class membership and used to determine training parameters for the classifier. For example, for a statistical classifier, mean and standard deviation data for each class over a plurality of features of interest can be determined for the set of training patterns. Alternatively, interconnection weights for some neural network classifiers can be obtained by setting the output of the classifier to represent the known output class of the sample and calculating appropriate interconnection weight values for the neural network to obtain the desired result.

At step 154, data is extracted from a test set of patterns, having known class membership, and provided to the classifier. The classifier determines two or more output classes for each pattern in the test set according to the extracted feature data to obtain at least two classifier outputs according to the provided training data and its associated classification technique. The determined classes are saved to memory along with the output scores associated with the determined class, and their associated rankings.

The results from the classifier are then sorted by ranking, confidence value, and class to form two or more confusion matrices at step 156. For example, the classifier results can be sorted into a plurality of categories, each category having an associated class, ranking, and range of output score values, a given range comprising a subset of the range of possible output score values. The accuracy of the classifier for each category can be determined by comparing the classification results for the test patterns within the category to their known class membership.

In an exemplary embodiment, the boundaries of the output score ranges are determined according to predefined percentiles within the test scores. In other words, the boundaries can be determined by partitioning the scores from the test samples equally into a desired number of output score bins. The boundary of each bin is defined by its highest and lowest value.

For example, assume that there are ten different classes. Each classifier outputs a ranked list of 10 values ranging from zero to one. Ten bins are desired. So, for each of the ten classes, there are ten ranked choices. For each choice, ten output score bins are created based on the values of however many outputs fall into a particular combination of class and ranking. The values are ordered in ascending order. The number of values used to determine bin boundaries is the total number of values that fall into that class-choice partition divided by the number of bins desired. If, in this example, one thousand values occur in a given combination of class and ranking, the range of the first bin is based on the first one hundred values. The range of the second bin is based on the second one hundred values and so on. The ranges will not necessarily be equal in extent. For example, the first bin may be between 0 and 0.135. The second bin may be between 0.136 and 0.312, and so on. Also, it should be noted that bin boundaries can differ for a given bin for a given choice for a given class. The determined boundary values are preserved and used to determine which bin an output value falls in. A confusion matrix is generated for each choice-bin combination. So we end up with ten choices×ten bins, or one hundred confusion matrices for each classifier.

At step 158, a look-up table can be constructed from the constructed confusion matrices. For example, a probability value can be calculated for one or more categories within the confusion matrices as the ratio of the number of samples within the category actually belonging to the class associated with the category to the total number of test samples that the classifier assigned to the category. A value need not be computed for every possible category, as some categories can have an inadequate number of samples to compute a useful value. A default value can be added to the table for these categories based upon knowledge of the classification application.

The determined value for a category is indicative of the conditional probability that an input pattern is a member of the associated class for the category, given the classification results. This value can be included as a weight value on the look-up table for that category or an appropriate value can be derived from it. Once the values for the table have been calculated, the generated look-up table is provided to an output mapping component associated with the classifier at step 160.

FIG. 6 illustrates a flow diagram depicting a classification method 200 for a multiple classifier system in accordance with an aspect of the present invention. The method begins at step 202, where an input pattern is classified at a plurality of pattern recognition classifiers. Each classifier provides two or more outputs, each output comprising a selected output class from a plurality of output classes associated with the system, an associated output score, and a ranking relative to the other outputs, if any. It will be appreciated that a single output can be provided with a default ranking value. Each output class selected by the classifiers is considered by the classification system as a potential output class for the system. It will be appreciated that the same output class can be selected at multiple classifiers, and thus multiple classifier outputs can be associated with each output class.

The method 200 advances to step 204, where the two or more outputs from each classifier are mapped to respective weight values according to their associated class, ranking, and output score. In an exemplary embodiment, a three-dimensional look-up table can be used to translate the classifier output into a desired weighting value. For example, one dimension of the table can include a series of output score ranges, with each range representing a portion of the total range of possible values for the output score.

Once the weighting values for each output are determined, the outputs are combined according to a voting algorithm at step 206. Any of a number of voting algorithms can be used to produce the combined weight values, such as Borda count voting scheme, sum rule combinations, and product rule combinations. Once the weight values for each class have been combined, the class having the largest combined weight value is selected as the system output at step 208.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

1. A method of classifying a subject into one of a plurality of output classes, comprising:
classifying an input pattern representing the subject at a plurality of pattern recognition classifiers to obtain a ranked set of at least two classifier outputs at each classifier, a classifier output including an associated output class, output score range, and ranking;
mapping each classifier output to a corresponding weight value according to its associated output class, output score range, and ranking; and
combining the weight values for the classifier outputs according to a voting algorithm to determine an output class associated with the subject.

2. The method of claim 1, wherein combining the weight values according to a voting algorithm comprises combining the weight values via a sum rule voting algorithm.

3. The method of claim 1, the weight value for a given classifier output representing the conditional probability that the associated class of the classifier output is the class associated with the subject given the associated class, output score, and ranking of the classifier output.

4. The method of claim 1, each of the plurality of classifiers receiving an input pattern representing the subject from an associated sensor.

5. The method of claim 1, further comprising selecting the output class having the largest combined weight value.

6. The method of claim 1, wherein combining the weight values according to a voting algorithm comprises combining the weight values via a product rule voting algorithm.

7. A method for generating output mapping weights for a classifier in a multiple classifier system, comprising
training the classifier on a plurality of training patterns;
classifying a plurality of test patterns, each test pattern having a known class membership, to obtain a ranked set of at least two classifier outputs for each test pattern, a given classifier output including an associated output class, an associated output score range from a plurality of defined output score ranges, and an associated ranking;
sorting the classifier outputs into a plurality of categories based on associated output classes, output score ranges, and rankings to generate at least two confusion matrices from the classifier outputs; and
generating weight values for at least one defined category of classifier outputs from at least two confusion matrices.

8. The method of claim 7, further comprising constructing a look-up table from the generated weight values, the look-up table providing a weight value for a given classifier output from the classifier based upon its associated class, output score, and ranking.

9. The method of claim 7, wherein the plurality of output score ranges include a plurality of boundaries defining the ranges, the boundaries being determined according to the distribution of the test results such that each output score range contains an equal number of test samples for a given combination of output class and ranking from a plurality of available output classes and rankings.

10. The method of claim 9, wherein the plurality of boundaries are different for each combination of output class and ranking.

11. A computer program product, recorded in a computer readable medium and operative in a data processing system, for classifying an input pattern into one of a plurality of output classes, comprising:
a plurality of pattern recognition classifiers, each classifier classifying the input pattern to obtain a ranked set of at least two classifier outputs, wherein a given classifier output includes an associated output class, output score range, and ranking;
a plurality of output mapping components, each output mapping component being associated with one of the pattern recognition classifiers and operative to map each output from the set of at least two classifier outputs from its associated classifier to a corresponding weight value according to its associated output class, output score range, and ranking; and
an arbitrator that combines the weight values for the classifier outputs according to a voting algorithm to determine an output class associated with the input pattern.

12. The computer program product of claim 11, wherein at least one of the plurality of output mapping components comprises a look-up table, the look-up table providing a weight value for a given classifier output according to its associated output class, output score, and ranking.

13. The computer program product of claim 11, the voting algorithm comprising a Borda count algorithm.

14. The computer program product of claim 11, at least one of the pattern recognition classifiers comprising a neural network classifier.

15. The computer program product of claim 11, the input pattern comprising at least one alphanumeric text character.

16. The computer program product of claim 15, further comprising a digital camera that acquires a block of text as a digital image for analysis.

17. The computer program product of claim 16, comprising a segmentation component that segments an alphanumeric character from the block of text.

18. The computer program product of claim 11, further comprising a plurality of feature extractors, each feature extractor being associated with one of the pattern recognition classifiers, that extract feature data from the input pattern and provide the feature data to their respective associated classifiers.

19. A computer program product, recorded in a computer readable medium and operative in a data processing system, for generating output mapping weights in a multiple classifier system, comprising
a pattern recognition classifier that classifies a plurality of test patterns, each test pattern having a known class membership, to obtain a ranked set of at least two classifier outputs for each test pattern, a given classifier output including an associated output class, an associated output score range from a plurality of output score ranges, and an associated ranking;
a matrix generation component that sorts the classifier outputs into a plurality of categories based on associated output classes, output score ranges, and rankings to generate at least two confusion matrices from the classifier outputs; and
a weight generation component that generates weighting values for at least one defined category of classifier outputs from at least two confusion matrices.

20. The computer program product of claim 19, wherein the weight generation component generates a look-up table from the generated weighing values.

21. The computer program product of claim 19, further comprising an output mapping component associated with the classifier, the output mapping component receiving the generated weight values from the weight generation component.

22. The method of claim 19, wherein the plurality of output score ranges include a plurality of boundaries defining the ranges, the boundaries being determined according to the distribution of the test results such that each output score range contains an equal number of test samples for a given combination of output class and ranking from a plurality of available output classes and rankings.

23. The method of claim 19, wherein the plurality of boundaries are different for each combination of output class and ranking.
